(19) United States
(12) Patent Application Publication
(10) Pub. No.: US 2010/0287506 A1
(43) Pub. Date: Nov. 11, 2010

(54) METHOD OF INTERACTING WITH A DISPLAY SYSTEM ON BOARD AN AIRCRAFT

(75) Inventor: Julien BARRY, Toulouse (FR)

Correspondence Address: OLIFF & BERRIDGE, PLC, P.O. BOX 320850, ALEXANDRIA, VA, 22320-4850, US

(73) Assignee: AIRBUS OPERATIONS, Toulouse (FR)

(21) Appl. No.: 12/770,202

(22) Filed: Apr. 29, 2010

(30) Foreign Application Priority Data
May 6, 2009 (FR) 0953031

(51) Int. Cl. G06F 3/048

(52) U.S. Cl. 715/823; 715/825

(57) ABSTRACT

In the method of interacting with a display system on board a aircraft: an operator sends to the system a selection of at least two symbols visible on a screen of a cockpit of the aircraft; and the system generates a list of elements associated with the selected symbols. Preferably at least one source system receives a notification from the display system indicating that at least one symbol visible on the screen and associated with the source system has been selected; and the source system generates a list including at least one element associated with the symbol.

### FIELD OF THE INVENTION

The invention relates to aircraft, and in particular to information display systems in the cockpit.

### BACKGROUND OF THE INVENTION

Airplanes are known in which the pilot can interact with symbologies used on electronic screens in the cockpit. These screens may be of the electronic instrument system (EIS) or of the control and display system (CDS) type. The formats displayed on the screens may be of the navigation display (ND) type, for example.

In the cockpit, it is conventional for the displays to display several kinds of format comprising several kinds of parameter (airplane speed, roll angle, . . . ), symbols (nearby traffic, ground beacons, . . . ), or indeed coherent symbologies (meteorological information, flight plans, . . . ).

Certain symbols or certain symbologies are interactive, insofar as the pilot can interact with any one of the display symbols. This enables functions associated with the symbols in question to be implemented.

The various different formats displayed on a single screen often come from different computers or systems of the airplane. Thus, the flight plan comes from the flight management system, while the data concerning nearby traffic comes from the system for monitoring the surroundings of the airplane. It is thus possible for a single screen to display a plurality of interactive symbologies coming from a plurality of different systems, and for symbols of these symbologies to overlap, at least in part.

The pilot has a pointer such as a cursor for selecting one of the symbols on the screen and transmitting the selection to the display system. Nevertheless, when symbols overlap, actuating the pointer selects all of the overlapping symbols. Under such conditions, when the pilot desires to act on only one of the overlapping symbols, it is still necessary to select all of them.

### OBJECT AND SUMMARY OF THE INVENTION

An object of the invention is to enable the pilot to choose only one symbol under all circumstances, even when the symbol overlaps other symbols.

To this end, the invention provides a method of interacting with a display system on board an aircraft, wherein;
an operator transmits to the system a selection of at least two symbols visible on a screen of a cockpit of the aircraft; and
the system generates a list of elements associated with the selected symbols.

Thus, by means of the list, the operator is in a position to choose separately any one of the elements associated with the overlapping symbols. And this individual choice can be transmitted to the display system.

Advantageously, the system marks at least one symbol on the screen having a pointer controlled by the operator in such a manner as to distinguish it from at least one other symbol visible on the screen, and/or marks it in a manner that is different from the way the symbol is marked when the pointer is not thereon.

Thus, the operator can easily identify the symbols on which the pointer lies.

In an implementation, the selected symbols overlap, at least in part.

Advantageously, the system is a display system and the selected symbols are associated with mutually different source systems, and the display system sends a notification to any source system that is associated with at least one of the selected symbols.

Thus, each of the source systems is informed that at least one symbol concerning it has been selected.

In an implementation, the list is a global list, with each source system sending to the display system a partial list containing at least one element corresponding to a selected symbol associated with said source system.

Thus, the display system can generate the global list from the partial list, thereby making it easier for the display system to create the list.

Advantageously:
the operator transmits to the system a choice of any one of the elements in the list; and
the system takes on a configuration in which interaction is temporarily prevented between the operator and the source system(s) associated with any symbols visible on the screen other than the chosen symbol.

This reduces any risk of the operator inadvertently interacting with a system that is not associated with the symbol that has been chosen.

The invention also provides a display system for an aircraft, the system comprising:
means enabling an operator to transmit to the system a selection of at least two symbols visible on a screen of a cockpit of the aircraft; and
means suitable for generating a list of elements associated with the selected symbols,

The invention also provides a method of transmitting data on board an aircraft, wherein:
at least one source system receives a notification from a display system indicating that at least one symbol visible on a screen of a cockpit of the aircraft and associated with the source system has been selected; and
the source system generates a list comprising at least one element associated with the symbol.

Although, as described above, this aspect of the invention is implemented in the display system, in this implementation of the invention this aspect of the invention is implemented in the source system.

The invention also provides a system for an aircraft, the system comprising means suitable, in response to a notification indicating that at least one symbol visible on a screen of a cockpit of the aircraft and associated with the system has been selected, for generating a list including at least one element associated with the symbol.

The invention also provides a computer program including code instructions suitable for executing a method according to either of the aspects of the invention when executed on a computer.

The invention also provides a data recording medium including a program of the invention recorded thereon.

Finally, the invention also provides for such a program to be made available on a telecommunications network for downloading.

### BRIEF DESCRIPTION OF THE DRAWINGS

Other characteristics and advantages of the invention appear further from the following description of an embodiment given by way of non-limiting example and with reference to the accompanying drawings, in which:

FIG. 1 shows an aircraft including an on-board system in an embodiment of the invention;

FIG. 2 is a diagrammatic view of the on-board system of the FIG. 1 aircraft;

FIG. 3 is a view of the screen of the FIG. 2 system with two overlapping symbols;

FIG. 4 is a diagram illustrating the running of a plurality of steps in the method of the invention; and

FIGS. 5 to 7 are views of the FIG. 3 screen illustrating certain steps in the method of FIG. 4.

### MORE DETAILED DESCRIPTION

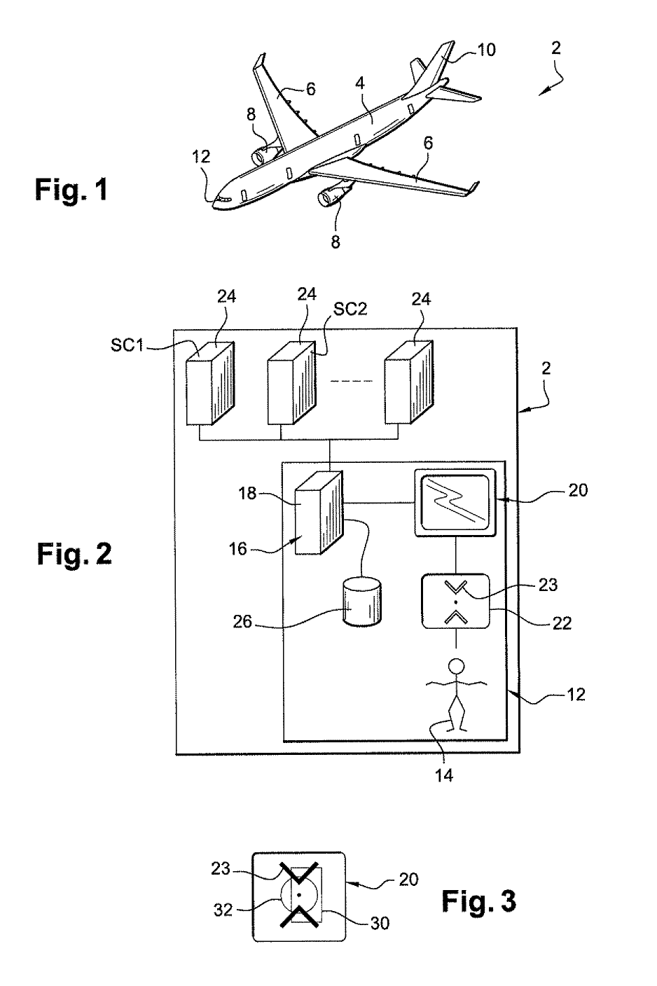

The method of the invention is implemented specifically on board an aircraft 2 as shown in FIG. 1. In the present example, the aircraft is an aerodyne and more particularly an airplane comprising a fuselage 4, two wings 6 provided with respective engines 8, and a tail fin 10. The airplane 2 has a cockpit 12 that is situated at the front of the fuselage and that is occupied by one or more pilots 14.

The cockpit includes a display system 16 or display having a central processor unit or computer 18 and at least one screen 20. Nevertheless, provision could be made for the processor unit not to be located in the cockpit. The screen 20 is shown again in FIG. 3 and in greater detail in FIG. 5.

The cockpit, and preferably the system 16, includes a pointer 22, e.g. in the form of a cursor or indicator enabling the pilot 14 to interact with the screen 20 and, via the screen, with the computer 18.

The airplane also has a plurality of systems 24 that are referred to herein as source systems SC. These comprise on-board systems each having at least one computer and performing various different functions. By way of example, the system SC1 is a flight management system and it supplies a flight plan. By way of example the system SC2 is a system for monitoring the environment of the airplane and it serves to display the nearby traffic.

In the present example, the method of the invention implements symbologies that are generated by means of an object-oriented protocol. The display system 16 thus has a database 26 forming a library of objects and symbols that are made available to systems 24. Each of these systems thus manages the symbology that is specific thereto by sending commands to the display system 16.

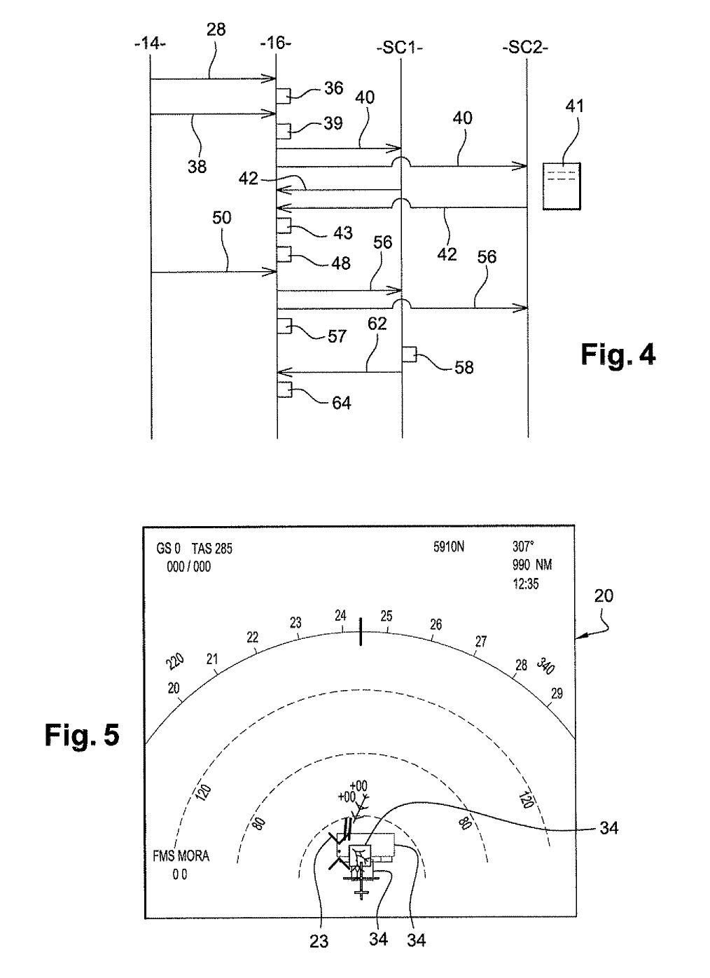

There follows a description given in particular to FIG. 4 of the various steps of the method of the invention in the present implementation.

In a first step 28, the pilot 14 moves the symbol 23 of the cursor 22 on the screen 20. As it moves, it can happen that the symbol 23 passes over at least one other symbol displayed on the screen, or possibly a plurality of such symbols. It is assumed in this example that the symbol 23 passes over a plurality of symbols 30 and 32 that overlap at least in part as shown in FIG. 3. By way of example, these symbols may represent an airplane.

When the symbol 23 of the cursor thus overlies one or more symbols, the display 16 responds in a step 36 by marking this or these symbols so as to distinguish them from other symbols that are visible at the same time on the screen. This marking is also performed in a manner that is different from any marking that this or these symbols had before the symbol of the cursor moved thereover. It thus serves to distinguish these symbols both in time and in space. This is the situation shown in FIG. 5. The marking may be performed by displaying a frame 34 on the screen for the or each symbol concerned. In FIG. 5, there are three frames 34 surrounding three respective symbols. Otherwise, or in addition, the marking may be produced by underlining the symbols or by making them brighter.

It is now assumed that the pilot 14 seeks to choose only one of these symbols 30, 32 that are overlapping in this way and that are marked by the cursor that overlies them. To do this, during a subsequent step 38, the pilot begins by selecting all the overlapping symbols. For this purpose, the pilot sends the selection of these symbols to the system 16. This operation may be performed by clicking on a button of the cursor, for example. The consequence of this action is to transmit the selection of all of the overlapping symbols 30 and 32 to the system 16.

In step 39, the system 16 detects those symbols that have been selected and identifies the source system(s) 24 with which the symbols correspond.

During a subsequent step 40, the system 16 sends a notification to each of the systems 24 that is associated with at least one of the symbols selected in this way. As shown in FIG. 4, the display thus sends a notification to the SC1 system 24 and a notification to the SC2 system 24, assuming that the symbol 30 relates to the SC1 system and the symbol 32 to the SC2 system. The display 16 thus sends to each of the source systems concerned a list of symbols belonging thereto and constituting at least one of the symbols that have been selected. In the same notification, the display informs these systems that a plurality of symbols have been selected so that the systems are informed that in subsequent steps of the method it is going to be necessary to make use of a list or menu for choosing only one of them.

During a subsequent step 42, each of the source systems 24 that has received a notification generates a partial list 41 including at least one entry or element that corresponds to the selected symbol that is associated with the source system. When a plurality of symbols associated with the same source system are selected, then the list has a plurality of elements associated with the respective symbols. The source system sends this partial list to the display.

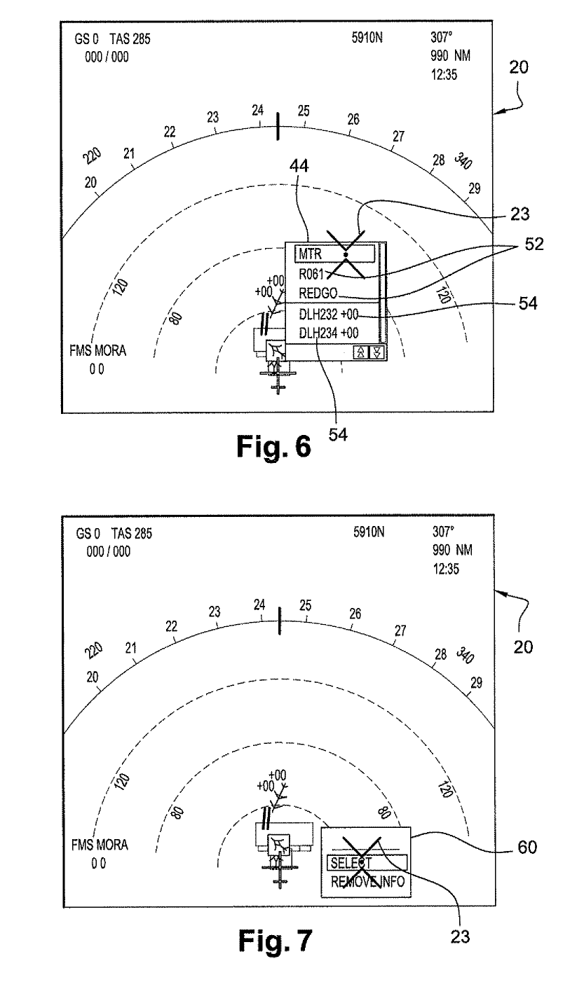

During a subsequent step 43, described with reference to FIG. 6, the display 16 generates a list 44 that is referred to herein as a “global” list. The global list has all of the entries as transmitted by the various source systems during step 42. It is the result of aggregating the partial lists 41. With reference to FIG. 6, the list 44 in this example comprises firstly elements 52 (R661 and REDGO) associated with flight management and secondly elements 54 (DLH232 and DLH234) associated with traffic. These correspond for example to the symbols that represent airplanes.

During a subsequent step 48, and still with reference to FIG. 6, the display 16 displays this list on the screen 20. The list is preferably in the form of a menu that occupies only a fraction of the surface of the screen.

The pilot 14 takes cognizance of the list on the screen. During a subsequent step 50, the pilot moves the pointer 22 over the list and selects the entry corresponding to the symbol with which the pilot wishes to interact. By actuating the pointer, e.g. by means of a click, the pilot informs the display of the element in the list that has been chosen.

During a subsequent step 56, the display 16 sends a notification to the source system associated with the element as chosen in this way to inform it that this is the element that has been chosen. The display 16 also informs the other source system(s) that none of their entries have been chosen.

During step 57, the display takes on a configuration in which any interaction between the pilot and this or these non-chosen source systems is temporarily prevented. For this purpose, the display is configured to make all or some of the symbology of a given system non-interactive. Here the display makes the symbologies of all of the non-chosen systems non-interactive. Control is thus given solely to the system SC1 that is associated with the chosen symbol.

The source system as selected in this way thus knows that it must enable the pilot to interact with the chosen element or symbol. This is step 58 that is also illustrated by FIG. 7. In this example, and with reference to FIG. 7, control is given to the air traffic system. The pilot interacts with the symbol that has been chosen on the screen and that corresponds to an airplane in this example. The selected source system may for example display a choice menu 60 on the screen proposing various actions to the pilot. These actions are symbolized specifically by the words “select” and “remove info”, respectively, and they relate to selecting the element or to removing it. During this time, the pilot is prevented from selecting symbols of other systems so as to avoid any risk of interfering with them while interacting with the chosen symbol.

The pilot selects an operation and the source system implements it.

Once the source system SC1 has finished the interaction between the pilot and the symbol, it notifies the end of this interaction to the display during a step 62.

Thereafter, during a step 64, the display returns control to all of the systems so that the pilot can once more select any of the symbols visible on the screen.

It is also possible, in addition, to describe a situation in which the pilot 14 selects a single symbol directly by means of the pointer 22 because only one symbol lies under the symbol 23 of the pointer at the time of selection. Under such circumstances, the display 16 detects that only one symbol has been selected and it identifies the source system to which the symbol belongs. it then gives control to that system only, preventing the pilot from interacting with the symbols of the other systems. At the same time, the display 16 notifies the system concerned that only one of its symbols has been selected and that no other symbol from any other system has been selected simultaneously. As a result, the source system in question knows that it needs to establish interaction between the pilot and the selected symbol. As can be seen, when only one symbol is selected, there is no need to pass via the step relating to choosing between symbols, and in particular steps involving the transmission of partial lists and displaying a global list so as to make it possible to choose one of the elements.

By way of example, the method of the invention may be implemented on a screen of a navigation display (ND) to manage multiple interactivity between the symbologies relating to the flight plan, to the traffic, and to the airport map, all three of which are managed by different source systems.

It can be seen that the invention enables a menu 44 to be generated that is displayed on the screen 20 with which the pilot 14 is interacting, which menu relates to the list of symbols that the pilot has selected, if any. It is via this menu that the pilot can choose one particular symbol with which to interact. Once this choice has been made, the display interrupts underactivity with the symbologies of the systems other than the system managing the chosen symbol so that the system managing the chosen symbol can manage interaction between the pilot and the symbol without that interaction being disturbed by interactivity with the other symbologies of other systems. It can also be seen that the menu is the result of combining data coming from a plurality of source systems. The method serves to give one system control over a screen so that that system acts via the display to manage interaction between one of its symbols and the pilot.

The method of the invention is controlled by the computer 18 concerning the steps involving the display 16, and by the computers 24 associated with the source systems concerning the steps involving them. Thus, all or some of the steps of the method may be implemented under the control of one or more computer programs comprising code instructions suitable for performing them.

It can thus be seen that the display system 16 comprises:
means, in particular formed by the pointer 22, enabling the pilot 14 to transmit a selection of at least two symbols 30, 32 visible on the screen 20 to the system;
means 18 suitable for generating a list 44 of the elements that are associated with the selected symbols; and
means, constituted in particular by the pointer 22, enabling the pilot to choose one of the elements of the list and transmit that choice to the system.

Likewise, each source system 24 includes means suitable, in response to a notification informing them that at least one symbol visible on the screen 20 has been selected, for generating a list 41 including at least one element associated with the symbol.

Specifically, these means are suitable for implementing the steps described above.

The invention also provides a data recording medium including the above-mentioned program in recorded form.

Finally, such a program may be made available on a telecommunications network for downloading.

Naturally, numerous modifications may be made to the invention without going beyond the ambit thereof. The number of overlapping symbols may be equal to three or more.

In the list, the elements associated with the symbols may be the symbols themselves, even though, in the implementation described above, these elements are different from the symbols.

Provision may be made for the display system to generate the list of elements associated with the selected symbols without receiving information from the source systems for this purpose.

1. A method of interacting with a display system on board an aircraft, wherein:
an operator transmits to the system a selection of at least two symbols visible on a screen of a cockpit of the aircraft; and
the system generates a list of elements associated with the selected symbols.

2. A method according to claim 1, wherein the system marks at least one symbol on the screen having a pointer controlled by the operator in such a manner as to distinguish it from at least one other symbol visible on the screen, and/or marks it in a manner that is different from the way the symbol is marked when the pointer is not thereon.

3. A method according to claim 1, wherein the selected symbols overlap, at least in part.

4. A method according to claim 1, wherein the system is a display system and the selected symbols are associated with mutually different source systems, and the display system sends a notification to any source system that is associated with at least one of the selected symbols.

5. A method according to claim 1, wherein the list is a global list, with each source system sending to the display system a partial list containing at least one element corresponding to a selected symbol associated with said source system.

6. A method according to claim 4, wherein:
the operator transmits to the system a choice of any one of the elements in the list; and
the system takes on a configuration in which interaction is temporarily prevented between the operator and the source system(s) associated with any symbols visible on the screen other than the chosen symbol.

7. A display system for an aircraft, wherein the system comprises:
means enabling an operator to transmit to the system a selection of at least two symbols visible on a screen of the aircraft; and
means suitable for generating a list of elements associated with the selected symbols.

8. A method of transmitting data on board an aircraft, wherein:
at least two source systems receive respective notifications from a display system indicating that at least one symbol visible on a screen of a cockpit of the aircraft and associated with that source system has been selected; and
each of the source systems generates a list comprising at least one element associated with the symbol.

9. A computer program including code instructions suitable for executing a method according to claim 1 when executed on a computer.

10. A data recording medium including the computer program according to claim 9 in recorded form.
